(19) United States
(12) Patent Application Publication
(10) Pub. No.: US 2013/0168128 A1
(43) Pub. Date: Jul. 4, 2013

(54) SUN-LIGHT RESISTANT SELF-LUBRICATED INSULATED CONDUCTOR

(71) Applicant: Viakable, S. A. DE C. V., San Nicolas de los Garza (MX)

(72) Inventor: Héctor Ricardo López-González, Saltillo (MX)

(73) Assignee: VIAKABLE, S. A. DE C. V., San Nicolas de los Garza (MX)

(21) Appl. No.: 13/730,936

(22) Filed: Dec. 29, 2012

Related U.S. Application Data
(60) Provisional application No. 61/581,549, filed on Dec. 29, 2011.

(51) Int. Cl. H01B 3/30

(52) U.S. Cl. CPC H01B 3/305
USPC 174/120 C

(57) ABSTRACT

A sun-light resistant self-lubricated electrical cable that includes one o more conductors, one or more layers of polyvinyl chloride (PVC) insulating coating surrounding the conductor, and a polyamide sheath surrounding the PVC insulating coating to provide sun-light resistant to said PVC insulating coating, the polyamide sheath is made of a nylon base resin with a hindered amine light stabilizer, an antioxidant; and an ultraviolet absorber.

### TECHNICAL FIELD OF THE INVENTION

The present application generally relates to sun-light resistant insulated conductors, and more specifically to self-lubricated, UV-stabilized electrical cables and methods for making the same.

### BACKGROUND OF THE INVENTION

The most common electrical cable used in housing and industrial projects in the United States is THHN, which stands for “Thermoplastic High Heat Nylon Coated Conductor”, as described in the National Electric Code (NEC). It consists of an electrical conductor, generally copper or aluminum, surrounded by a polyvinyl chloride (PVC) insulation, which is in turn surrounded by a polyamide or equivalent jacket. This product is thoroughly described in UL Standard 83.

When THHN conductors are installed in cable ducts, it is often necessary to provide a lubricant on the outer surface of the cable in order to reduce the friction force. Alternatively, THHN can be manufactured with a polyamide sheath that contains additives that effectively reduce the coefficient of friction, as disclosed, for instance, in US Patent Application publication 20100255186. In this patent application publication is described a masterbatch composition comprising a blend of silicon elastomer and ethylene polymer modified with an unsaturated aliphatic diacid anhydride is disclosed. This masterbatch can be melt blended with a polyamide to provide a composition having a much reduced coefficient of friction which is particularly useful in cable sheaths for THHN cables. This lowered friction force makes possible that said THHN cables are easy to install.

THHN cables are often installed in locations were they are exposed to direct sun-light, typically in cable trays. Sun-light resistance is usually measured by means of a test described in UL Standards 83 and 2556 and consists in subjecting cable samples to the combined effect of sun-light radiation and water cycles within a xenon arc rotating chamber. After 720 hours of exposure, both the PVC insulation and polyamide sheath must retain at least 80 percent of their original tensile and elongation.

It has been long known that polyamide polymers are attacked by sun-light radiation, specifically by the ultraviolet (UV) component of the spectrum. For many years a finely dispersed carbon black pigment has been used to protect polyamides and other organic polymers from the deleterious effects of UV rays. However, when cable sheaths need to be have a color other than black, it is necessary to use additives called UV absorbers to provide adequate protection.

It would thus be desirable to have an easy to install, sun-light resistant THHN cable with a sheath having a color other than black. More specifically, it would be desirable to have a THHN cable sheath made from a polyamide and silicon elastomer masterbatch with sun-light resistance properties and a low coefficient of friction and having a color other than black.

### SUMMARY OF THE INVENTION

In view of the above mentioned and the purpose of providing solutions to the constraints encountered, it is the object of the invention to provide a electrical cable, comprising one or more conductors; one or more layers of polyvinyl chloride (PVC) insulating coating surrounding the conductor; and a polyamide sheath surrounding the PVC insulating coating to provide sun-light resistant to the PVC insulating coating, the polyamide sheath includes a nylon base resin; a hindered amine light stabilizer; an antioxidant; and an ultraviolet absorber.

### BRIEF DESCRIPTION OF THE DRAWINGS

The characteristic details of the present invention are described in the following paragraphs, together with the figures related to it, in order to define the objectives of this invention, but not limiting the scope of it.

FIG. 1 illustrates a sectional perspective view of a sun-light resistant self-lubricated electrical cable according to the invention.

FIG. 2 illustrates a scanning electron microscopy (SEM) picture and silicon map for THHN cable sheath made with a polyamide and silicon elastomer masterbatch.

FIG. 3 illustrates a model of the light interaction of the sun-light resistant self-lubricated electrical cable according to the invention.

### DETAILED DESCRIPTION OF THE INVENTION

The characteristic details of this invention are described in the following paragraphs, which have the objective of defining the invention, but without limiting its scope.

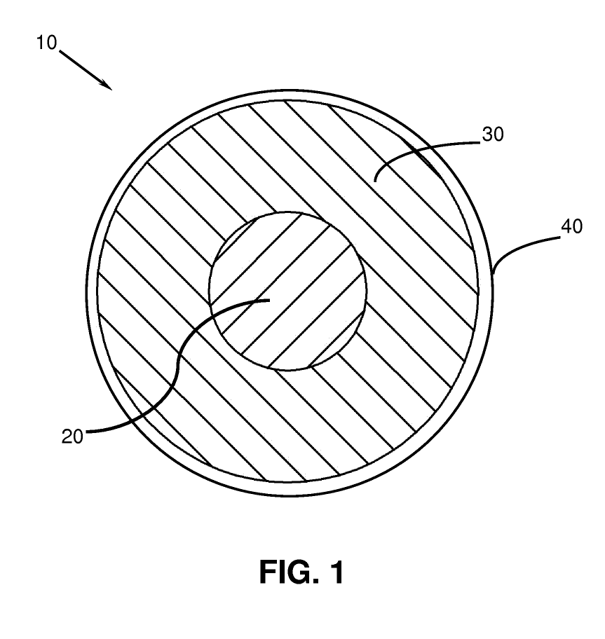

In FIG. 1, an electrical cable 10 of the present invention includes one or more conductors 20, one or more layers of insulating coatings 30 surrounding the conductor 20, and a polyamide sheath 40 surrounding the insulating coating 30.

The electrical cable 10 is a THHN cable made by extruding a polyvinyl chloride (PVC) layer (insulating coating 30) and the polyamide sheath 40 on the solid or stranded conductor 20. The polyamide sheath 40 can be applied simultaneously with the PVC insulating coating 30 by means of the same crosshead or it can be applied using another crosshead, in a configuration commonly described as tandem. As described in the aforementioned US patent application publication, a masterbatch containing silicon elastomer is the preferred manner to incorporate a silicon elastomer into a polyamide matrix.

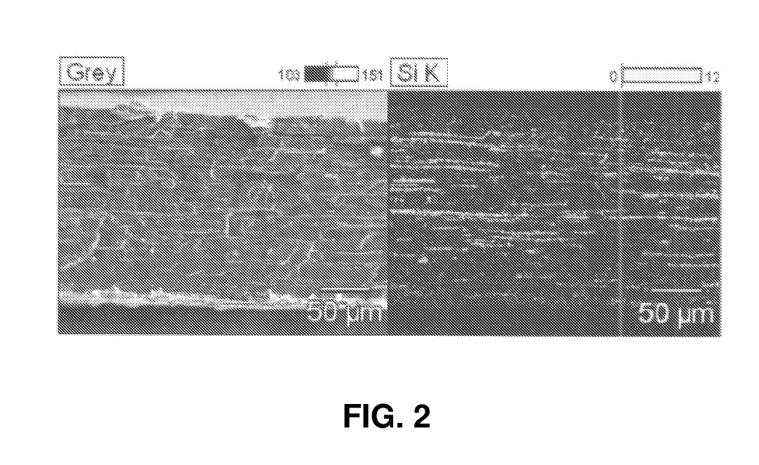

Typically both polyamide and silicon masterbatch are tumble blended prior to feeding them into the extruder hopper. Proper mixing must take place inside of the screw section of the machine in order to provide a homogeneous layer. For this application it is typical to use a blend of about 10-20 weight percent of said masterbatch and the reminder of a polyamide such as nylon 6 or nylon 66. In order to reach its full friction reduction potential, the silicon elastomer must be thoroughly dispersed within the polyamide matrix, as shown in FIG. 2.

In order to provide color and sun-light resistance to the polyamide sheath 40 it is necessary to add a color pigment and a UV absorber the polyamide-silicon elastomer composition. The state of the art teaches that many organic and inorganic compounds can be used as UV absorbers. However, it was surprisingly discovered that not all UV absorbers reported in the literature provide satisfactory protection to the polyamide-silicon elastomer composition.

### Composition of the Insulating Coating

The composition of the insulating coating 30 according to the invention is a polyvinyl chloride (PVC) base resin. Podrían profundizar un poquito más en la composición de esta cubierta aislante.

### Composition of the Polyamide Sheath

The composition of the polyamide sheath 40 according to the invention shows compounds, which in turn may consist of multiple components. The components are described individually below, without necessarily being described in any order of importance.

### Nylon

Any suitable nylon may be employed as the base resin in the composition of the polyamide sheath according to the present invention. The nylon base resin may be virtually any polyamide resin prepared, for example, by polymerization of diamines and dicarboxylic acids and/or of aminocarboxylic acids or the corresponding lactams as is well known per se. The preferred nylons will therefore have polyamide units of the following structural formula:

—NH—(CH2)n-CO—

where n is an integer which is preferably 6, 9, 10, 11 or 12.

Particularly preferred nylon base resins for use in the composition of the polyamide sheath of the present invention include nylon-6 (polycaprolactam), nylon-6,6 (polyhexamethylene adipamide), nylon-6,9 (polyhexamethylene azelaamide), nylon-6,10 (polyhexamethylene sebacamide), nylon-6,12 (polyhexamethylene dodecanoamide), nylon-11 (polyundecanoamide), and nylon-12 (polydodecanoamide).

The nylon base resin is present in an amount of 95% to 99% by weight of the composition of the polyamide sheath.

### Hindered Amine Light Stabilizer

The composition of the polyamide sheath prepared according to the present invention can include at least one hindered amine light stabilizer (hereinafter “HALS”). Typically, the HALS is added to the nylon base resin and acts as a photon scavenger. Typically, the HALS reacts with UV light from sunshine to protect the bulk polymer matrix from photodegradation. The damaging radiation is absorbed by these additives and is typically converted into harmless heat.

In certain embodiments, the HALS can be selected from 1,3-benzenedicarboxamide, N,N′-bis(2,2,6,6-tetramethyl-4-piperidinyl) (Nylostab SEED®); 2,2,6,6-tetramethyl-4-piperidon; 2,2,6,6-tetramethyl-4-piperidinol; bis-(1,2,2,6,6-pentamethylpiperidyl)-(3′,5′-di-tert-butyl-4′-hydroxybenzyl)-butylmalonate; bis-(2,2,6,6-tetramethyl-4-piperidinyl)-decanedioate (Tinuvin® 770); bis-(2,2,6,6-tetramethyl-4-piperidinyl)-succinate (Tinuvin® 780); bis-(1-octyloxy-2,2,6,6-tetramethyl-4-piperidinyl)-sebacate (Tinuvin® 123); bis-(1,2,2,6,6-pentamethyl-4-piperidinyl)-sebacate (Tinuvin® 765); tetrakis-(2,2,6,6-tetramethyl-4-piperidyl)-1,2,3,4-butanetet racarboxylate; N,N′-bis-(2,2,6,6-tetramethyl-4-piperidyl)-hexane-1,6-diamine; N-butyl-2,2,6,6-tetramethyl-4-piperidina mine; 5-(2,2,6,6-tetra methyl-4-piperidinyl)-2-cyclo-undecyl-oxazole) (Hostavin®. N20); 1,1′-(1,2-ethane-di-yl)-bis-(3,3′,5,5′-tetramethyl-piperazin one) (Goodrite® UV3034); 8-acetyl-3-dodecyl-7,3,9,9-tetramethyl-1,3,8-triazaspiro(4,5)decan-2,4-dione (Tinuvin® 440); 1,2,3,4-butane-tetracarboxylic acid-1,2,3-tris(1,2,2,6,6-pentamethyl-4-piperidinyl)-4-tride cylester (Mark® LA62); N-2,2,6,6-tetramethyl-4-piperidinyl-N-amino-oxamide (Lucheme HAR100); 4-acryloyloxy-1,2,2,6,6-pentamethyl-4-piperidine; mixture of esters from 2,2,6,6-tetramethyl-4-piperidinol and fatty acids (Cyasorb® UV3853); propanedioic acid, [(4-methoxyphenyl)methylene]-, bis(1,2,2,6,6-pentamethyl-4-pi peridinyl) ester (Sanduvor® PR 31); formamide, N,N′-1,6-hexanediylbis[N-(2,2,6,6-tetramethyl-4-piperidinyl (Uvinul® 4050H); 1,5-dioxaspiro(5,5)undecane 3,3-dicarboxylic acid, bis(2,2,6,6-tetramethyl-4-peridinyl) ester (Cyasorb® UV-500); 1,5-dioxaspiro(5,5)undecane 3,3-dicarboxylic acid, bis(1,2,2,6,6-pentamethyl-4-peridinyl)ester (Cyasorb® UV516); 3-dodecyl-1-(2,2,6,6-tetramethyl-4-piperidyl)-pyrrolidin-2,5-dione (Cyasorb® UV3581); and 3-dodecyl-1-(1,2,2,6,6-pentamethyl-4-piperidyl)-pyrrolidin-2,5-dione. In certain embodiments, the hindered amine light stabilizer includes at least one piperidine functional group, and more preferably the hindered amine light stabilizer includes at least one polyalkyl substituted piperidine functional group, and even more preferably the hindered amine light stabilizer is bis-(2,2,6,6-tetramethyl-4-piperidinyl)-decanedioate (Tinuvin® 770).

In certain embodiments, the HALS is selected from 1,3,5-triazine-2,4,6-triamine; N′,N′″-(ethanediylbis-(4,6-bis-(butyl(1,2,2,6,6-pentamethyl-4-piperidinyl-amino)-1,3,5-triazine-2-yl)-iminopropanedil)-N′,N″-dibutyl-N′,N″-bis-(1,2,2,6,6-pentamethyl-4-piperidinyl); poly-methylpropyl-3-oxy-4-(2,2,6,6-tetramethyl-piperidinyl-siloxane; octa-decene-(N-(2,2,6,6,-tetramethylpiperidinyl-4-N-maleic imido oxalic acid diamide) copolymer; and poly-(6-morpholine-5-triazine-2,4-diyl)-2,2,6,6-tetramethyl-4-piperidinyl)-hexa-methylene-2,2,6,6-tetramethyl-4-piperidinyl)-imino.

Preferably, the hindered amine light stabilizer is 1,3-benzenedicarboxamide, N,N′-bis(2,2,6,6-tetramethyl-4-piperidinyl) (Nylostab SEED®).

The hindered amine light stabilizer is present in an amount of 0.5% to 1.5% by weight of the composition of the polyamide sheath.

### Antioxidant Additives

Antioxidants present in the composition of the polyamide sheath help to prevent oxidation of sheath. Exemplary antioxidants can include sterically hindered phenols, phosphites and phosphonites. In certain embodiments, at least two antioxidants can be included in the nylon base resin. In certain other embodiments, the nylon base resin can include two antioxidants. In certain embodiments, the first antioxidant can be selected from a sterically hindered phenolic antioxidant and the second antioxidant can be selected from phosphite ester antioxidant.

In certain embodiments, the antioxidant can be a phenolic based antioxidant. Exemplary phenolic antioxidants can include sterically hindered phenolic antioxidant, alkylated monophenols, alkylthiomethylphenols, hydroquinones and alkylated hydroquinones, tocopherols, hydroxylated thiodiphenyl ethers, alkylidene bisphenols, O-, N- and S-benzyl compounds, hydroxybenzylated malonates, hydroxybenzyl aromatic compounds, triazine compounds, benzylphosphonates, acylaminophenols, esters of β-(3,5-di-tert-butyl-4-hydroxyphenyl)propionic acid with monohydric or polyhydric alcohols, esters of β-(5-tert-butyl-4-hydroxy-3-methylphenyl)propionic acid with monohydric or polyhydric alcohols, esters of β-(3,5-dicyclohexyl-4-hydroxyphenyl)propionic acid with monohydric or polyhydric alcohols, esters of 3,5-di-tert-butyl-4-hydroxyphenylacetic acid with monohydric or polyhydric alcohols, and amides of β-(3,5-di-tert-butyl-4-hydroxyphenyl)propionic acid.

Specific antioxidants that may be used with the present composition include: N,N′-hexane-1,6-diybis(3-(3,5-ditert-butyl-4-hydroxyphenylpropionamide)) (Irganox® 1098); 2,6-di-t-butyl-4-methylphenol; 2,6-di-t-butyl-4-ethylphenol; octadecyl 3,5-di-t-butyl-4-hydroxy-hydrocinnamate (Irganox® 1076); benzenepropanoic acid, 3,5-bis(11,1-dimethylethyl)-4-hydroxy-methyl ester (Ralox 35); benzenepropanoic acid, 3,5-bis(1,1-dimethylethyl)-4-hydroxy-isooctyl ester (Irganox® 1135); benzenepropanoic acid, 3,5-bis(1,1-dimethyl ethyl)-4-hydroxy-C13-15 branched and linear alkyl esters (Anox® BF); benzenepropanoic acid, 3,5-bis(1,1-dimethylethyl)-4-hydroxy; 2,2′-methylenebis(6-t-butyl-4-methylphenol) (Cyanox® 2246); 2,2′-methylenebis 6-(1-methylcyclohexyl)-p-cresol (Lowinbx® WSP); 4,4′-butylidenebis(6-t-butyl-3-methyl-phenol) (Santhowhite® powder); 1,1,3-tris(2-methyl-4-hydroxy-5-t-butyl phenyl) butane (Topanol® CA); N,N′-hexamethylene bis(3,5-di-t-butyl-4-hydroxyhydrocinnamamide; 2,2′-ethylidenebis(4,6-di-t-butylphenol) (Isonox® 129); 4,4′-methylenebis(2,6-di-t-butylphenol) (Ethanox 702); tri-ethylene-glycol-bis-3-(t-butyl-4-hydroxy-5-methyl-phenyl)-propionate (Irganox® 245); 1,6-hexane-diol-bis-3-(3,5-di-t-butyl-4-hydroxyphenyl)-propionate (Irganox® 259); butylated hydroxyanisole (Teenox® BHA); 2,6-di-t-butyl-4-sec-butyl-phenol (Isonox® 132); 2,6-di-t-butyl-4-n-butyl-phenol; 2,6-di-t-butyl-4-nonyl-phenol (Isonox® 232); 2,6-di-methyl-6-(1-methyl-cyclohexyl)-phenol (Lowinox® WSL); 2,4-di-methyl-6-(1-methyl-6-(1-methyl pentadecyl)-2-propyleneacid, 2-isopentane-6-[(3-isopentane-2-hydroxy-5-isopentane-phenyl)-ethyl]-4-methyl-phenyl-ester (Sumilizer® GS); 2-propylene-acid, 2-t-butyl-6-[(3-t-butyl-2-hydroxy-5-methyl-phenyl)-methyl]4-methyl-phenyl-ester (Sumilizer® GM); di-ethyl-ester of 3,5-di-t-butyl-4-hydroxy-benzyl-phosphoric acid (Irganox® 1222); 2,5,7,8-tetra-methyl-2-(4′,8′,12′-tri-methyl-tri-decyl)-6-chromanol (Ronotec® 201); N,N′-1,3-propanediylbis(3,5-di-t-butyl-4-hydroxyhydrocinnamamide); calcium bis[monoethyl(3,5-di-t-butyl-4-hydroxy benzyl)phosphonate (Irganox® 1425).

In certain embodiments, the sterically hindered phenolic antioxidant can be: N,N′-hexane-1,6-diybis(3-(3,5-ditert-butyl-4-hydroxyphenylpropionamide)) (Irganox® 1098).

In certain embodiments, the antioxidant can be a phosphite ester antioxidant.

Exemplary phosphite ester antioxidant can include triphenyl phosphite, diphenyl isodecyl phosphite, phenyl diisodecyl phosphite, 4,4′-butylidene-bis(3-methyl-6-t-butylphenylditridecyl)phosphite, cyclic neopentanetetraylbis(octadecyl phosphite), tris(nonylphenyl) phosphite, diisodecyl pentaerythritol diphosphite, 9,10-dihydro-9-oxa-10-phosphaphenanthrene-10-oxide, or 2,2′-methylenebis(4,6-di-t-butylphenyl)octyl phosphite.

In certain embodiments, the phosphite ester antioxidant can be tris-(2,4-di-tert-butylphenyl) phosphite.

The antioxidant is present in an amount of 0.3% to 0.1% by weight of the composition of the polyamide sheath. In certain embodiments, the antioxidant is a mixture of sterically hindered phenolic antioxidant and phosphite ester antioxidant having a weight ratio of 1:1.

### Ultraviolet Absorber

The ultraviolet absorber present in the composition of the polyamide sheath is an ultraviolet absorber of the hydroxyphenyl benzotriazole class.

In certain embodiments, the ultraviolet absorber can be 2-(2′-Hydroxyphenyl)benzotriazoles, for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol].

In certain embodiments, the ultraviolet absorber can be 2-(2H-benzotriazol-2-yl)-4,6-bis(1-methyl-1-phenylethyl)phenol (Tinuvin® 234).

The ultraviolet absorber is present in an amount of 0.5% to 1.5% by weight of said polyamide sheath

As described herein, the naylon base resin can include at least one HALS, at least one antioxidant, and at least one ultraviolet absorber. The combination of HALS, antioxidants, and ultraviolet absorber can result in an overall synergistic effect, thereby increasing the overall stability and lifetime of the polyamide sheath and provide sun-light resistant to the PVC insulating coating.

### EXAMPLES OF EMBODIMENTS OF THE INVENTION

The invention will now be described with respect to the following examples, which are solely for the purpose of representing the way of carrying out the implementation of the principles of the invention. The following examples are not intended as a comprehensive representation of the invention, nor try to limit the scope thereof.

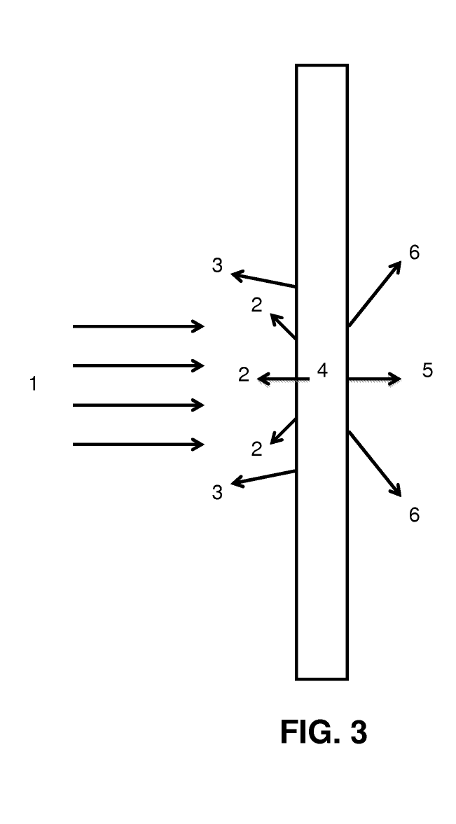

The experiments shown both in the results table of the cables as in the results table of films, has the objective to show that it is not obvious that the same results will be obtained by conducting the weatherproof test on films or on electrical cables, and that an important effect on the behavior of light while effectuating directly on a film, or effectuating on a film that is mounted on another material. In our case, this support is the PVC insulating coating 30 and the film and the skin of Nylon protected against ultraviolet degradation. In the FIG. 3, as there is a support material behind the Nylon film, a certain amount of incident light (1) that is absorbed (4) and penetrates the nylon film (5), must influence the PVC insulation causing part of this light that achieved to penetrate the Nylon film is regularly reflected (2), or reflected dispersely (3), returning to influence on the Nylon film on the opposite face. Thus we assume that the tests carried out on cables are more severe than those carried out directly on films as shown in the reported data. Additionally, the data show that any additive added to the Nylon adequately protects it adequately from degradation by ultraviolet light.

A THHN cable, having a conductor size of 8 AWG (8.36 mm²), was made using a conventional PVC insulation and a sheath made from 88 weight percent of nylon-6 (Nycoa 1637), 12 weight percent of a silicon elastomer masterbatch and varying amounts of a 1:1 blend of two conventional UV absorbers: UV absorber Phenol, 2-(5-chloro-2H-benzotriazole-2-yl)-6-(1,1-dimethylethyl)-4-methyl—(Tinuvin 326, CAS No. 3896-11-5) and UV absorber 2-(2H-benzotriazol-2-yl)-4,6-bis(1-methyl-1-phenylethyl)phenol (Tinuvin 234, CAS No. 70321-86-7). According to prior art references, this UV additive blend is reported to provide effective protection against sun-light conditions to polyamide and other organic polymer materials. The silicon elastomer masterbatch was made according to the procedure described in US Patent application publication 20100255186, and was made from 69.44 weight percent of a silicon elastomer (Silplus® SE 6060, Cas No. 70131-67-8), 27.77 weight percent of a ethylene polymer grafted with unsaturated aliphatic diacid anhydride (Fusabond® MB E265), 2.08 weight percent of synthetic precipitated amorphous silica (Hisil 233, Cas No. 112926-00-8) and 0.69 weight percent of polyethylene wax (Epolene N 14P, Cas No. 9002-88-4). The jacket thickness was nominally 0.005 in.

The cable samples 1, 2 and 3 were subjected to a sun-light resistance test during 720 hours, as described in UL Standard 83. The results, shown in Table 1, indicate that the UV absorber blend, contrary to prior art reports, does not provide satisfactory sun-light resistance between the concentration range of 0.5 to 2 weight percent, based on the polyamide content.

TABLE 1
Effect of conventional UV absorbers on the weathering of the polyamide-
silicon elastomer blend

| | | Example | | |
|---|---|---|---|---|
| | | 1 | 2 | 3 |
| UV absorber blend concentration, % | | 0.50 | 1 | 2 |
| Unaged | Tensile strength, psi | 6732 | 6969 | 6815 |
| | Elongation, % | 262 | 281 | 281 |
| After 720 h in | Tensile strength retention, % | 73 | 60 | 79 |
| Weather-o-meter | Elongation retention, % | 10 | 9 | 9 |

Another experiment was conducted to investigate the effect of a polyethylene-based color concentrate on the weathering behavior of the poliamide-silicon elastomer compound. A blend of these components, expressed in weight percent, was made from 86.5% of nylon 6, 11.5% of the silicon elastomer masterbatch described earlier and 2% of a polyethylene-based color concentrate. Films having 0.14 mm in thickness were prepared and subjected to weathering aging for 720 h according to UL Standard 83. The results, shown in Table 2, indicate that the polyamide-silicon elastomer blend containing a polyethylene-based color concentrate does not satisfy the requirements of the cable specification which require a minimum of 80 percent retention values in both tensile strength and elongation.

TABLE 2
Effect of polyethylene-based color concentrate on the weathering of
polyamide-silicon elastomer blend

| | | Example |
|---|---|---|
| | | 4 |
| polyethylene-based color concentrate, % | | 2 |
| Unaged | Tensile strength, psi | 8937 |
| | Elongation, % | 241 |
| After 720 h in Weather-o-meter | Tensile strength retention, | 63 |
| | % | |
| | Elongation retention, % | 10 |

In another study, a THHN cable, having a 6 AWG (13.3 mm²) conductor size was made as described earlier, except that instead of the UV absorber blend, two concentrations of 1,3-benzenedicarboxamide, N,N′-bis(2,2,6,6-tetramethyl-4-piperidinyl), sold as Nylostab S-EED from Clariant, Muttenz, Switzerland, were used. This UV additive will be referred to as UV absorber 3. The cable samples 5 and 6 were similarly subjected to sun-light resistance testing. The results, shown in Table 3, indicate that this UV absorber 3 is effective in protecting the polyamide jacket from weathering effects, allowing this cable to meet the sun-light resistance requirement set forth in UL Standard 83.

TABLE 3
Effect of the addition of 1,3-benzenedicarboxamide, N,N′-
bis(2,2,6,6-tetramethyl-4-piperidinyl) on the weathering of the
polyamide-silicon elastomer blend

| | | Example | |
|---|---|---|---|
| | | 5 | 6 |
| UV absorber 3 concentration, % | | 1 | 2 |
| Unaged | Tensile strength, psi | 9900 | 8349 |
| | Elongation, % | 308 | 292 |
| After 720 h in Weather- | Tensile strength retention, % | 82 | 93.5 |
| o-meter | Elongation retention, % | 89 | 97 |

This is a desirable result. However, it is still necessary to better understand the artificial weathering behavior of this polyamide-silicon elastomer compound by virtue of its multiphase character. It is long known that silicon elastomers are not compatible with polyamide 6. In fact, as FIG. 2 shows, the silicon elastomer phase is clearly visible in a SEM picture. However, the aforementioned silicon elastomer masterbatch also contains a ethylene polymer modified with an unsaturated aliphatic diacid anhydride, which is also incompatible with the polyamide 6 used.

It is also desirable to add a color concentrate, different than black, to the polyamide-silicon elastomer compound in order to impart color to it. There are many known methods to incorporate a color pigment into thermoplastics, the best known being adding a color concentrate, also known as color masterbatch. These color masterbatches are made by mixing a thermoplastic carrier with a high concentration of color pigment. For this application is desirable to use color concentrates having a polyamide carrier or a polyethylene carrier. It is more desirable to use color concentrates having a polyethylene carrier for cost reasons, since color concentrates having a polyamide carrier are significantly more expensive. In addition, polyethylene based concentrates would be compatible with the ethylene modified polymer contained in the silicon elastomer masterbatch, thus providing a better distribution of the color pigment within the polyamide-silicon elastomer blend.

Another samples 7 to 23, and the results are shown in the following Tables 4, 5, 6, and 7.

TABLE 4

| | Samples | | | | |
|---|---|---|---|---|---|
| | 7 | 8 | 9 | 10 | 11 |
| Time of test-ASTM G | 720 | 720 | 720 | 720 | 720 |
| 155-1 (hours) | | | | | |
| Conductor size | 6 AWG | 4 AWG | 4 AWG | 4 AWG | 8 AWG |
| PVC insulating coating | 1110 | 1133 | 1110 | 1996 U | 1133 |
| PVC color | Green | White | White | White | White |
| Thickness of polyamide | 5.79 | 6.14 | 5.93 | 6.80 | 5.53 |
| sheath (mil) | | | | | |
| Composition of | % | % | % | % | % |
| polyamide sheath | | | | | |
| Nylon Nycoa1627 | 100 | 98 | 98 | 98 | 98 |
| Nylon Nycoa W1 | | | | | |
| Nylon Nycoa W2 | | | | | |
| Nylostab SEE-D | | 2 | 2 | 2 | 2 |
| Hostavin VSU | | | | | |
| Tinuvin 234 | | | | | |
| Lowilite 326 | | | | | |
| Irgafos 168 | | | | | |
| Irganox 1098 | | | | | |
| Tensile strength | 53 | 54 | 64 | 53 | 65 |
| retention, % | | | | | |
| Elongation retention, % | 18 | 44 | 34 | 30 | 18 |

TABLE 5

| | Samples | | | | |
|---|---|---|---|---|---|
| | 12 | 13 | 14 | 15 | 16 |
| Time of test-ASTM G | 720 | 720 | 720 | 720 | 720 |
| 155-1 (hours) | | | | | |
| Conductor size | 8 AWG | 8 AWG | 8 AWG | 8 AWG | 8 AWG |
| PVC insulating coating | 1110 | 1996 | 1110 | 1110 | 1110 |
| PVC color | White | White | White | White | White |
| Thickness of polyamide | 5.64 | 5.62 | 6.67 | 6.26 | 7.13 |
| sheath (mil) | | | | | |
| Composition of | % | % | % | % | % |
| polyamide sheath | | | | | |
| Nylon Nycoa1627 | 98 | 98 | | | 97 |
| Nylon Nycoa W1 | | | 100 | | |
| Nylon Nycoa W2 | | | | 100 | |
| Nylostab SEE-D | 2 | 2 | | | 1 |
| Hostavin VSU | | | | | |
| Tinuvin 234 | | | | | 1 |
| Lowilite 326 | | | | | |
| Irgafos 168 | | | | | 0.5 |
| Irganox 1098 | | | | | 0.5 |
| Tensile strength | 65 | 61 | 113 | 76 | 91 |
| retention, % | | | | | |
| Elongation retention, % | 18 | 19 | 100 | 89 | 96 |

TABLE 6

| | Samples | | | | |
|---|---|---|---|---|---|
| | 17 | 18 | 19 | 20 | 21 |
| Time of test-ASTM G | 720 | 720 | 720 | 720 | 720 |
| 155-1 (hours) | | | | | |
| Conductor size | 8 AWG | 8 AWG | 8 AWG | 8 AWG | 8 AWG |
| PVC insulating coating | 1110 | 1110 | 1996 | 1996 | 1996 |
| PVC color | White | White | White | White | White |
| Thickness of polyamide | 6.81 | 6.32 | 5.73 | 5.5 | 6.51 |
| sheath (mil) | | | | | |
| Composition of | % | % | % | % | % |
| polyamide sheath | | | | | |
| Nylon Nycoa1627 | 97 | 97 | | | 97 |
| Nylon Nycoa W1 | | | 100 | | |
| Nylon Nycoa W2 | | | | 100 | |
| Nylostab SEE-D | 1 | | | | 1 |
| Hostavin VSU | | 1 | | | |
| Tinuvin 234 | | 1 | | | 1 |
| Lowilite 326 | 1 | | | | |
| Irgafos 168 | 0.5 | 0.5 | | | 0.5 |
| Irganox 1098 | 0.5 | 0.5 | | | 0.5 |
| Tensile strength | 86 | 80 | 91 | 67 | 92 |
| retention, % | | | | | |
| Elongation retention, % | 93 | 95 | 95 | 60 | 90 |

TABLE 7

Samples

| | 22 | 23 |
|---|---|---|
| Time of test-ASTM G 155-1 (hours) | 720 | 720 |
| Conductor size | 8 AWG | 8 AWG |
| PVC insulating coating | 1996 | 1996 |
| PVC color | White | White |
| Thickness of polyamide sheath (mil) | 6.54 | 6.02 |
| Composition of polyamide sheath | % | % |
| Nylon Nycoa1627 | 97 | 97 |
| Nylon Nycoa W1 | | |
| Nylon Nycoa W2 | | |
| Nylostab SEE-D | 1 | |
| Hostavin VSU | | 1 |
| Tinuvin 234 | | 1 |
| Lowilite 326 | 1 | |
| Irgafos 168 | 0.5 | 0.5 |
| Irganox 1098 | 0.5 | 0.5 |
| Tensile strength retention, % | 88 | 101 |
| Elongation retention, % | 94 | 107 |

Although the present invention has been described by way of particular embodiments and examples thereof, it should be noted that it will be apparent to persons skilled in the art that modifications may be applied to the present particular embodiment without departing from the scope of the present invention.

1. A electrical cable, comprising:
one or more conductors;
one or more layers of polyvinyl chloride (PVC) insulating coating surrounding the conductor; and
a polyamide sheath surrounding the PVC insulating coating to provide sun-light resistant to said PVC insulating coating, wherein the polyamide sheath includes:
a nylon base resin;
a hindered amine light stabilizer;
an antioxidant; and
an ultraviolet absorber.

2. The electrical cable of claim 1, wherein said nylon base resin is present in an amount of 95% to 99% by weight of said polyamide sheath.

3. The electrical cable of claim 1, wherein said nylon base resin is selected from a group consisting of nylon-6 (polycaprolactam), nylon-6,6 (polyhexamethylene adipamide), nylon-6,9 (polyhexamethylene azelaamide), nylon-6,10 (polyhexamethylene sebacamide), nylon-6,12 (polyhexamethylene dodecanoamide), nylon-11 (polyundecanoamide), nylon-12 (polydodecanoamide), and combinations thereof.

4. The electrical cable of claim 3, wherein said nylon base resin is nylon-6.

5. The electrical cable of claim 1, wherein said hindered amine light stabilizer is present in an amount of 0.5% to 1.5% by weight of said polyamide sheath.

6. The electrical cable of claim 1, wherein said hindered amine light stabilizer is selected from a group consisting of 1,3-benzenedicarboxamide, N,N′-bis(2,2,6,6-tetramethyl-4-piperidinyl); 2,2,6,6-tetramethyl-4-piperidon; 2,2,6,6-tetramethyl-4-piperidinol; bis-(1,2,2,6,6-pentamethylpiperidyl)-(3′,5′-di-tert-butyl-4′-hydroxybenzyl)-butylmalonate; bis-(2,2,6,6-tetramethyl-4-piperidinyl)-decanedioate; bis-(2,2,6,6-tetramethyl-4-piperidinyl)-succinate; bis-(1-octyloxy-2,2,6,6-tetramethyl-4-piperidinyl)-sebacate; bis-(1,2,2,6,6-pentamethyl-4-piperidinyl)-sebacate; tetrakis-(2,2,6,6-tetramethyl-4-piperidyl)-1,2,3,4-butanetet racarboxylate; N,N′-bis-(2,2,6,6-tetramethyl-4-piperidyl)-hexane-1,6-diamine; N-butyl-2,2,6,6-tetramethyl-4-piperidinamine; 5-(2,2,6,6-tetramethyl-4-piperidinyl)-2-cyclo-undecyl-oxazole); 1,1′-(1,2-ethane-di-yl)-bis-(3,3′,5,5′-tetramethyl-piperazin one); 8-acetyl-3-dodecyl-7,3,9,9-tetramethyl-1,3,8-triazaspiro(4,5)decan-2,4-dione; 1,2,3,4-butane-tetracarboxylic acid-1,2,3-tris(1,2,2,6,6-pentamethyl-4-piperidinyl)-4-tride cylester; N-2,2,6,6-tetramethyl-4-piperidinyl-N-amino-oxamide; 4-acryloyloxy-1,2,2,6,6-pentamethyl-4-piperidine; mixture of esters from 2,2,6,6-tetramethyl-4-piperidinol and fatty acids; propanedioic acid, [(4-methoxyphenyl)methylene]-,bis(1,2,2,6,6-pentamethyl-4-piperidinyl)ester; formamide, N,N′-1,6-hexanediylbis[N-(2,2,6,6-tetramethyl-4-piperidinyl; 1,5-dioxaspiro(5,5)undecane 3,3-dicarboxylic acid, bis(2,2,6,6-tetramethyl-4-peridinyl)ester; 1,5-dioxaspiro(5,5)undecane 3,3-dicarboxylic acid, bis(1,2,2,6,6-pentamethyl-4-peridinyl)ester; 3-dodecyl-1-(2,2,6,6-tetramethyl-4-piperidyl)-pyrrolidin-2,5-dione; 3-dodecyl-1-(1,2,2,6,6-pentamethyl-4-piperidyl)-pyrrolidin-2,5-dione; bis-(2,2,6,6-tetramethyl-4-piperidinyl)-decanedioate; 1,3,5-triazine-2,4,6-triamine; N′,N′″-(ethanediylbis-(4,6-bis-(butyl(1,2,2,6,6-pentamethyl-4-piperidinyl-amino)-1,3,5-triazine-2-yl)-iminopropanedil)-N′,N″-dibutyl-N′,N″-bis-(1,2,2,6,6-pentamethyl-4-piperidinyl); poly-methylpropyl-3-oxy-4-(2,2,6,6-tetramethyl-piperidinyl-siloxane; octa-decene-(N-(2,2,6,6,-tetramethylpiperidinyl-4-N-maleic imido oxalic acid diamide) copolymer; poly-(6-morpholine-S-triazine-2,4-diyl)-2,2,6,6-tetramethyl-4-piperidinyl)-hexa-methylene-2,2,6,6-tetramethyl-4-piperidinyl)-imino; and combinations thereof.

7. The electrical cable of claim 6, wherein said hindered amine light stabilizer is 1,3-benzenedicarboxamide, N,N′-bis(2,2,6,6-tetramethyl-4-piperidinyl).

8. The electrical cable of claim 1, wherein said antioxidant is present in an amount of 0.3% to 0.1% by weight of said polyamide sheath.

9. The electrical cable of claim 1, wherein said antioxidant is a mixture of sterically hindered phenolic antioxidant and phosphite ester antioxidant.

10. The electrical cable of claim 9, wherein said mixture is sterically hindered phenolic antioxidant and phosphite ester antioxidant having a weight ratio of 1:1 of said polyamide sheath.

11. The electrical cable of claim 9, wherein the sterically hindered phenolic antioxidant is N,N′-hexane-1,6-diybis(3-(3,5-ditert-butyl-4-hydroxyphenylpropionamide)).

12. The electrical cable of claim 9, wherein the phosphite ester antioxidant is tris-(2,4-di-tert-butylphenyl)phosphite.

13. The electrical cable of claim 1, wherein said ultraviolet absorber is present in an amount of 0.5% to 1.5% by weight of said polyamide sheath.

14. The electrical cable of claim 1, wherein said ultraviolet absorber is 2-(2H-benzotriazol-2-yl)-4,6-bis(1-methyl-1-phenylethyl)phenol.

15. The electrical cable of claim 1, wherein said electrical cable is sun-light resistant and self-lubricated.
